(19) United States
(12) Patent Application Publication
(10) Pub. No.: US 2026/0234432 A1
(43) Pub. Date: Aug. 13, 2026

(54) LED CURABLE BINDER SYSTEMS

(71) Applicant: ASK Chemicals LLC, Wilmington, DE (US)

(72) Inventors: Rafael A. Magalhaes, Rio Carlos (BR); Rogerio S.J. Piccolo, Sao Carlos (BR)

(21) Appl. No.: 19/049,628

(22) Filed: Feb. 10, 2025

(51) Int. Cl. C09D 163/10; C08K 3/22; C08K 5/526; C09D 4/06; C09D 7/61; C09D 7/63; C09K 3/14

(52) U.S. Cl. CPC C09D 163/10; C09D 4/06; C09D 7/61; C09D 7/63; C09K 3/1436; C08K 2003/2227; C08K 5/526

(57) ABSTRACT

The present invention relates to binder systems which are curable using LED curing lamps emitting relatively longwave UV radiation and/or visible light. The binder systems include an epoxy acrylate resin, a photoinitiator, one or more reactive monomer species. Also disclosed are methods of manufacturing bonded abrasive products using the present binder systems.

### CROSS-REFERENCE TO RELATED APPLICATIONS

This application is a nonprovisional patent application that makes no priority claim.

### FIELD

The application relates to binder compositions and, more particularly, to binder compositions that are curable using LED curing lamps emitting longwave UV or visible light.

### BACKGROUND

The manufacture of bonded abrasive products such as sandpaper and cleaning sponges generally require the use of a binder to bind an abrasive material onto a substrate. Often, the binder is a phenolic resin that must be fully cured in order to produce the final product. In such processes, curing the phenolic resin requires heating the resin (typically after being applied to the substrate) in ovens at temperatures ranging from 50° C. to 200° C. Skilled artisans will appreciate, however, that there are drawbacks to such processes including the high capital costs of the equipment (such as exhaust fans for capturing gasses generated during the curing process), the intensive energy consumption such equipment requires, and hazardous working conditions.

Accordingly, those skilled in the art continue with research and development efforts in the field of binders for bonded abrasive applications.

### SUMMARY OF THE INVENTION

Disclosed are LED curable binder system that include an epoxy acrylate resin or precursors therefor, a photoinitiator, and at least one reactive monomer.

In some embodiments, the binder system includes acrylic acid and an epoxy resin based on epichlorohydrin and bisphenol A. In other embodiments, the binder system includes an epoxy acrylate resin obtained as the reaction product of acrylic acid and an epoxy resin based on epichlorohydrin and bisphenol A. In these embodiments, the epoxy acrylate resin may be provided in an amount ranging from about 55 wt. % to about 85 wt. %, based on the total weight of the binder system.

In some embodiments, the binder system includes a Type 1 photoinitator such as ethyl phenyl (2,4,6-trimethylbenzoyl) phosphinate. In these embodiments, the photoinitiator may be provided in an amount ranging from about 3 wt. % to about 10 wt. %, based on the total weight of the binder system.

In some embodiments, the binder system includes, as a reactive monomer, at least one of acrylic acid, trimethylolpropane triacrylate, 2-hydroxypropyl methacrylate, and 2-hydroxyethyl acrylate. In these embodiments, the reactive monomer(s) maybe provided in an amount ranging from about 5 wt. % to about 42 wt. %, based on the total weight of the binder system.

In some embodiments, the binder system includes a free radical scavenger such as triphenyl phosphite. In these embodiments, the free radical scavenger may be provided in an amount ranging from about 0.01 wt. % to about 0.1 wt. %, based on the total weight of the binder system.

In some embodiments, the viscosity of the binder system ranges from about 1,000 cP to about 3,000 cP, as measured by a Brookfield rotational viscometer equipped with spindle #18 at 25° C. In other embodiments, the viscosity of the binder system is no greater than 200 cP, as measured by a Brookfield rotational viscometer equipped with spindle #18 at 25° C.

In some embodiments, the binder system comprises a Part I component and a separate Part II component, wherein the Part I component comprises the epoxy acrylate resin and the Part II component comprises the photoinitiator.

Also disclosed is a method of manufacturing bonded abrasive products using binder systems according to the present invention, particularly sandpaper.

In some embodiments, the method includes the steps of: applying an embodiment of the binder system onto a substrate; coating the binder with an abrasive grain; and curing the binder under a LED curing lamp. In these embodiments, the substrate may include kraft paper. In these embodiments, the binder may be applied to the substrate in a single layer, preferably at a thickness of less than or equal to 1 mm. In these embodiments, the abrasive grain may include a medium-fine abrasive grain, preferably an abrasive grain with a grit number of about 600, and more preferably 600 grit aluminum oxide abrasive grain. In these embodiments, the curing step may be performed using an LED curing lamp configured to emit radiation of a wavelength ranging from about 360 nm to about 400 nm. In these embodiments, the curing step may be performed with the LED curing lamp positioned at a distance of about 10 cm from the binder.

Other examples of the disclosed binder systems, and methods of manufacturing bonded abrasive products, will become apparent from the following detailed description, the accompanying drawings and the appended claims.

### BRIEF DESCRIPTION OF THE DRAWINGS

FIG. 1 is a bar graph plotting the number of passes until loss of grain was observed for several tested sandpaper samples; and

FIG. 2 is a bar graph plotting the amount of weight loss observed for several tested sandpaper samples.

### DETAILED DESCRIPTION

The ultraviolet (UV) spectrum includes electromagnetic radiation (EM) of wavelengths ranging from about 10 nm to about 400 nm. The visible light spectrum incudes EM radiation of wavelengths ranging from about 380 nm to about 750 nm.

The UV spectrum is commonly divided into bands (also referred to as “regions”) based on certain wavelength ranges. For example, the ISO standard ISO 21348 provides two different conventions for doing so: (1) the UVA, UVB, and UVC bands and (2) the near UV, middle UV, far UV, and extreme UV bands. The wavelength ranges for UVA, UVB, and UVC are 315-400 nm, 280-315 nm, and 100-280 nm, respectively. The wavelength ranges near UV, middle UV, far UV, and extreme UV are 300-400 nm, 200-300 nm, 122-200 nm, and 10-121 nm, respectively.

The present invention broadly relates to binder systems that are curable by exposure to relatively long wavelength UV radiation, such as UVA, or visible light. This presents several benefits over current binder systems which can only be cured using relatively short wavelength UV radiation, such as UVC. For example, longer wavelength EM radiation is less hazardous than shorter wavelength EM radiation and requires less energy to produce. Further, longer wavelength EM radiation can be produced by light emitting diode (LED) curing lamps whereas shorter wavelength EM radiation typically require mercury vapor lamps or excimer lamps; LED curing lamps are typically less expensive and require less energy to operate than mercury vapor lamps or excimer lamps.

Binder systems according to the present invention are at least useful for bonded abrasive applications, i.e., binding an abrasive material onto a substrate during the manufacture of bonded abrasive products such as, but not limited to, sandpaper and cleaning sponges. Since the present binder systems can be cured without thermal curing equipment such as ovens and exhaust systems, it is contemplated that the present binder systems represent an improvement over the current phenolic resins utilized in bonded abrasive applications due to being less hazardous and more energy efficient.

Binder systems according to the present invention include an epoxy acrylate resin, a suitable photoinitiator, and one or more reactive monomers. The vinyl groups (—C═C—) present in the acrylate groups of the epoxy acrylate resin enable the resin to undergo photopolymerization via free radical polymerization. The photoinitiator provides a means for generating free radicals and can be activated by exposure to radiation. The reactive monomers facilitate the formation of a crosslinked network. In addition to the components described above, some embodiments of the binder system may further include a free radical scavenger and/or other additives.

The epoxy acrylate resin may be provided in the form of a pre-polymerized epoxy acrylate resin or as precursors that form an epoxy acrylate resin once polymerized. In embodiments involving the latter, D.E.R. (Dow epoxy resin) Grade 331 (herein, “DER 331”) (CAS No. 25085-99-8) and acrylic acid (CAS: 79-10-7) have been found to be suitable precursors. DER 331 is the liquid reaction product of epichlorohydrin and bisphenol A. DER 331 is considered a general-purpose epoxy resin and is commercially available from Olin Epoxy of Clayton, Missouri. DER 331 polymerizes with acrylic acid when heated in a slightly acidic environment to form epoxy acrylate resin.

In preferred embodiments of the binder system, the epoxy acrylate resin may be provided in an amount ranging from about 40 wt. % to about 90 wt. %, preferably about 55 wt. % to about 85 wt. %, based on the total weight of the binder system.

Photoinitiators are categorized as being “Type I” or “Type II” based on the initiation mechanism involved. Type I photoinitiators undergo cleavage (homolytic bond scission) upon absorbing light, resulting in the formation of reactive radicals that can initiate a polymerization or curing process. Type I photoinitiators can function in the absence of oxygen and do not require a coinitiator. In contrast, Type II photoinitiators typically involve a sensitization mechanism where the photoinitiator absorbs light and then transfers the energy to another molecule (often a coinitiator) to generate radicals, often leading to a charge transfer or electron transfer process.

Embodiments of the binder system preferably include a Type 1 photoinitiator. In particular, phosphine oxide-based photoinitiators such as ethyl phenyl (2,4,6-trimethylbenzoyl) phosphinate (CAS No.: 84434-11-7) have been found to be suitable. Ethyl phenyl (2,4,6-trimethylbenzoyl) phosphinate is a polyphenol phosphite ester and is sold commercially as Omnirad LED 2805, which is available from IGM Resins (Brazil).

In preferred embodiments of the binder system, the photoinitiator may be provided in an amount ranging from about 1 wt. % to about 15 wt. %, preferably about 3 wt. % to about 10 wt. %, based on the total weight of the binder system.

Suitable reactive monomers include monomers capable of photopolymerizing with the epoxy acrylate resin. In general, vinyl group-containing monomers have been found to be suitable, particularly acrylic acid and certain acrylates such as trimethylolpropane triacrylate (TMPTA) (CAS No. 28961-43-5), 2-hydroxypropyl methacrylate (2-HPMA) (CAS No. 27813-02-1), and 2-hydroxyethyl acrylate (2-HEA) (CAS No. 818-61-1). TMPTA is a tri-functional acrylate ester whereas 2-HPMA and 2-HEA are hydroxyalkyl acrylates. Embodiments of the binder system may include one or more of these reactive monomers.

In preferred embodiments of the binder system, the reactive monomers may be provided in an amount ranging from about 1 wt. % to about 55 wt. %, preferably about 5 wt. % to about 42 wt. %, based on the total weight of the binder system.

In embodiments where acrylic acid is provided as an epoxy acrylate resin precursor, a second quantity of acrylic acid may also be provided as a reactive monomer. In such embodiments, the two quantities of acrylic acid may be provided separately.

Like with many oligomeric resin systems, epoxy acrylate resins (including those formed from DER 331 and acrylic acid) tend to be highly viscous (approx. 400 to 5,000 cP). To lower the viscosity to a more readily workable level, one or more diluents may be added. In preferred embodiments, the viscosity of the binder would be no greater than 200 cP (as measured by a Brookfield rotational viscometer equipped with spindle #18 at 25° C.) to ensure that the binder is relatively easy to handle and can be applied uniformly onto substrates.

It is noted that the reactive monomers listed above (acrylic acid, TMPTA, 2-HPMA, and 2-HEA), with a minimum concentration of 98%, do lower the viscosity of the epoxy acrylate resin when added, thereby serving as a diluent. As such, these monomers are particularly preferred since it has been found that they can lower the viscosity of epoxy acrylate resins to 200 cP or less (as measured by a Brookfield rotational viscometer equipped with spindle #18 at 25° C.) without the need for dedicated diluents.

Embodiments of the binder system may further include a free radical scavenger to help neutralize free radicals and/or reactive oxygen species generated during photopolymerization, which may help prevent or mitigate inhibited polymerization rates, and may also help prevent or mitigate oxidative degradation of the photopolymer and/or the components of the binder system. In particular, triphenyl phosphite (TPP) (CAS No. 101-02-2) (a polyphenol phosphite ester) has been found to be a suitable free radical scavenger.

In preferred embodiments of the binder system, the free radical scavenger may be provided in an amount ranging from about 0.01 wt. % to about 0.1 wt. %, based on the total weight of the binder system.

Components of the binder system may be provided as single pre-mixed composition or instead kept/stored separately as two or more parts until used. In particular, it may be desirable to keep the photoinitiator separate from the epoxy acrylate resin until used. In an exemplary embodiment, the binder system includes a Part I component and a Part II component; the Part I component includes an epoxy acrylate resin, a stabilizer, and one or more reactive monomer species to serve a diluent; the Part II component includes a photoinitiator and one or more reactive monomer species.

Binder systems according to the present invention may be cured via exposure to relatively long wavelength UV radiation and/or visible light. In particular, EM radiation of wavelengths ranging from about 360 nm to about 420 nm is preferred, or more preferably from about 390 nm to about 400 nm.

In preferred embodiments, an LED curing lamp may be utilized to cure binder systems according to the present invention. In particular, the Fast Curing System One model, available from Doxa Technologies Brazil, has been found to be suitable. The Fast Curing System One model is a 240-watt LED curing lamp configured to produce 390-395 nm light.

### Experiment

DER 331, acrylic acid, TMPTA and TPP were brought together in a kettle and mixed to combine. The quantity for each component is listed below in Table 1.

TABLE 1
Base Resin

| Reagent | Quantity Used (grams) | Weight Percent (%) |
|---|---|---|
| TMPTA | 889.95 | 59.63 |
| acrylic acid | 157.05 | 10.52 |
| DER 311 | 444.0 | 29.75 |
| TPP | 1.5 | 0.10 |

After being brought together and mixed, the mixture was heated in the kettle to 91-93° C. and held in that temperature range for 10 minutes. The temperature was then slowly raised over the course of 55-60 minutes to 122-125° C. and held there until the acid value of the mixture was between 0.5-10.0 mg KOH/g. The mixture was then cooled to 45-50° C. and analyzed using a Brookfield rotational viscometer (spindle #18 at 25° C.) to ensure that the viscosity is between 1,000-3,000 cP. With the viscosity in the appropriate range, the mixture was discharged, giving the base resin. The base resin was codified as RI-1308.

A series of four dilutions was prepared by mixing the RI-1308 base resin with either 2-hydroxypropyl methacrylate or 2-hydroxyethyl acrylate, with three of the dilutions further containing a quantity of acrylic acid. These dilutions were codified as D-9701, D-9700, D-9699, and D-9698. Components and quantities thereof for these dilutions are listed below in Table 2.

TABLE 2
Dilutions

| | Base Resin | Acrylic Acid | 2- HPMA | 2- HEA |
|---|---|---|---|---|
| Dilution | (%) | (%) | (%) | (%) |
| D-9701 | 74.07 | 0 | 25.93 | 0 |
| D-9700 | 74.07 | 1.48 | 0 | 24.44 |
| D-9699 | 70.72 | 4.53 | 24.75 | 0 |
| D-9698 | 71.73 | 4.59 | 0 | 23.67 |

After preparing the dilutions, the photoinitiator ethyl phenyl (2,4,6-trimethylbenzoyl) phosphinate was added to each dilution in the amount of 6.5% by weight, giving four binder systems ready for photopolymerization. Each of these binder systems are in accordance with the present invention. These binder systems are sometimes referred to below as simply “the binders”.

The viscosities of these binders were tested using a Brookfield rotational viscometer (spindle #18 at 25° C.). The results are presented below in Table 3.

TABLE 3

| Binder | Viscosity (cP) |
|---|---|
| D-9701 | 150 |
| D-9700 | 111 |
| D-9699 | 180 |
| D-9698 | 134 |

An initial experiment was performed to evaluate cure quality and flexibility. Test samples for this experiment were prepared by applying each binder to a piece of kraft paper in a single layer and curing the binders under a LED curing lamp for 15 seconds. None of the binder layers exceeded 1.0 mm in thickness for each test sample and any excess binder was manually removed prior to coating. The curing lamp was the Fast Curing System One model, available from Doxa Technologies Brazil. When used to cure, the curing lamp was positioned at a distance of 10 cm from the binder layer, which produced a 210 mm×90 mm rectangular exposure area. After curing, each test sample was visually and tactilely inspected to determine whether the binders had cured completely and also bent by hand to determine if the binders were flexible. As to both metrics, all test samples were found to be satisfactory.

A second experiment was performed to evaluate the efficacy of each binder for bonded abrasive applications. Test samples for this experiment were prepared by applying each binder to a piece of kraft paper in a single layer, coating the binders with 600 grit aluminum oxide abrasive grain, and curing the binders under a LED curing lamp for 15 seconds. None of the binder layers exceeded 1.0 mm in thickness for each test sample. The weight of the paper with binder applied was approximately 0.1 g for each test sample. Any excess binder was manually removed prior to coating and any excess abrasive grain was removed by flipping over the paper and tapping it. The LED cure lamp used was the same as in the initial experiment and was also kept at a distance of 10 cm from the test samples when used to cure. The kraft paper and the abrasive grain are commercially available from several suppliers, including Saint-Gobain Brazil. As a final preparatory step, each test sample was cut into the shape of 6×10 cm rectangles.

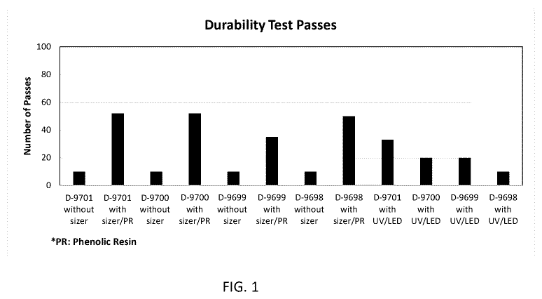

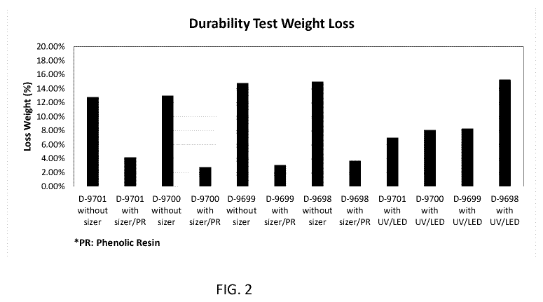

The 6×10 cm test samples were weighed once initially, and then a second time after being immersed in water for 4 hours. The wet test samples were then individually equipped to a toolhead and used to sand an aluminum plate. The number of passes was counted until each test sample showed loss of grain, and then the sanding continued until each test sample underwent 100 passes in total. After sanding, each test sample was dried to constant weight, and the final weight was recorded. The results are presented in FIGS. 1 and 2. The results for the test samples created using binders according to the present invention and cured using the LED cure lamp are denoted as “with UV/LED”.

As shown in FIG. 1, the test sample made using binder D-9701 required more than 30 passes before it showed any loss of grain, the test samples made using binders D-9700 and D-9699 required about 20 passes before it showed any loss of grain, and the test sample made using binder D-9698 required about 10 passes before it showed any loss of grain.

As shown in FIG. 2, the test sample made using binder D-9701 experienced a total weight loss of about 7%, the test samples made using binders D-9700 and D-9699 experienced a total weight loss of about 8%, and the test sample made using binder D-9698 experienced a total weight loss of about 15%.

From FIGS. 1 and 2, it was determined that binder D-9701 produced the best durability results, with binders D-9700 and D-9699 performing similarly. Additionally, it was unexpected that binder D-9698 would require a third of the number of passes as binder D-9701 before it showed loss of grain, and that it would experience approx. twice the amount of weight loss.

Also shown in FIGS. 1 and 2 are the results for test samples made using binders D-9701, D-9700, D9699, and D-9698 that were not cured using the LED cure lamp, both with and without a phenolic resin sizer (topcoat).

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A binder system that is curable by UV-A or visible light, the binder system comprising:
an epoxy acrylate resin or precursors therefor;
a Type I photoinitiator; and
at least one reactive monomer.

2. The binder system of claim 1, wherein:
the binder system comprises acrylic acid and an epoxy resin based on epichlorohydrin and bisphenol A.

3. The binder system of claim 1, wherein:
the binder system comprises an epoxy acrylate resin provided in an amount ranging from about 55 wt. % to about 85 wt. %, based on the total weight of the binder system.

4. The binder system of claim 1, wherein:
the Type I photoinitiator comprises ethyl phenyl (2,4,6-trimethylbenzoyl) phosphinate.

5. The binder system of claim 1, wherein:
the Type I photoinitiator is provided in an amount ranging from about 3 wt. % to about 10 wt. %, based on the total weight of the binder system.

6. The binder system of claim 1, wherein:
the at least one reactive monomer comprises at least one of: acrylic acid, trimethylolpropane triacrylate, 2-hydroxypropyl methacrylate, and 2-hydroxyethyl acrylate.

7. The binder system of claim 1, wherein:
the reactive monomer is provided in an amount ranging from about 5 wt. % to about 42 wt. %, based on the total weight of the binder system.

8. The binder system of claim 1, further comprising:
a free radical scavenger.

9. The binder system of claim 8, wherein:
the free radical scavenger comprises triphenyl phosphite.

10. The binder system of claim 8, wherein:
the free radical scavenger is provided in an amount ranging from about 0.01 wt. % to about 0.1 wt. %, based on the total weight of the binder system.

11. The binder system of claim 1, wherein:
the viscosity of the binder system ranges from about 1,000 cP to about 3,000 cP, as measured by a Brookfield rotational viscometer equipped with spindle #18 at 25° C.

12. The binder system of claim 1, wherein:
the viscosity of the binder system is no greater than 200 cP, as measured by a Brookfield rotational viscometer equipped with spindle #18 at 25° C.

13. The binder system of claim 1, wherein:
the binder system comprises a Part I component and a separate Part II component;
the Part I component comprises the epoxy acrylate resin; and
the Part II component comprises the photoinitiator.

14. A method of manufacturing bonded abrasive products comprising:
applying the binder of claim 1 onto a substrate;
coating the binder with an abrasive grain; and
curing the binder under a LED curing lamp.

15. The method of claim 14, wherein:
the substrate comprises kraft paper.

16. The method of claim 14, wherein:
the binder is applied to the substrate in a single layer, preferably at a thickness of less than or equal to 1 mm.

17. The method of claim 14, wherein:
the abrasive grain comprises a medium-fine abrasive grain, preferably an abrasive grain with a grit number of about 600, and more preferably 600 grit aluminum oxide abrasive grain.

18. The method of claim 14, wherein:
the curing step is performed using a LED curing lamp configured to emit radiation of a wavelength ranging from about 360 nm to about 400 nm.

19. The method of claim 18, wherein:
the curing step is performed with the LED curing lamp positioned at a distance of about 10 cm from the binder.
